(19) United States
(12) Patent Application Publication
(10) Pub. No.: US 2026/0119250 A1
(43) Pub. Date: Apr. 30, 2026

(54) INTENT-BASED SPECIFICATION OF ARTIFICIAL INTELLIGENCE AGENTS USING ARTIFICIAL INTELLIGENCE

(71) Applicant: BOOMI, LP, Conshohocken, PA (US)

(72) Inventors: Ayush PARASHAR, Foster City, CA (US); Lomesh AGRAWAL, Toronto (CA); Arindam CHOUDHURY, Bangalore (IN); Kashif MOHAMMAD, Nagpur (IN)

(73) Assignee: BOOMI, LP, Conshohocken, PA (US)

(21) Appl. No.: 19/249,607

(22) Filed: Jun. 25, 2025

(30) Foreign Application Priority Data
Oct. 25, 2024 (IN) 202411081538

(51) Int. Cl. G06F 9/50

(52) U.S. Cl. CPC G06F 9/5027

(57) ABSTRACT

State-of-the-art platforms for the development of artificial intelligence (AI) agents typically require users to manually define and configure each component of an AI agent. This results in a high barrier of entry for new AI agents, a high likelihood of errors, long development cycles, and inefficiencies, especially for non-technical users. Accordingly, embodiments use artificial intelligence to generate a complete specification of an AI agent based on a user's intent, for example, as expressed in natural language. In an embodiment, the intent is converted into a structured intent, from which one or more tasks are determined. Next, one or more tools are identified for each task, and one or more guardrails are generated for the AI agent. The user may modify the AI-agent specification, as needed or desired, via an intuitive interface, before the AI agent is generated and deployed.

### CROSS-REFERENCE TO RELATED APPLICATIONS

The present application claims priority to Indian Patent Application number 202411081538, filed on Oct. 25, 2024, which is hereby incorporated herein by reference as if set forth in full.

### BACKGROUND

### Field of the Invention

The embodiments described herein are generally directed to artificial intelligence (AI), and, more particularly, to intent-based specification of artificial intelligence (AI) agents using artificial intelligence.

### Description of the Related Art

A number of platforms exist that enable users to construct artificial intelligence (AI) agents. An AI agent is a software entity that utilizes artificial intelligence to autonomously perform one or more tasks, in order to achieve an objective set by a human, other software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective.

Existing platforms typically require users to manually define and configure each component of the AI agent, including the tasks, tools, guardrails, and the like. Thus, users must possess significant technical knowledge and spend considerable time and effort to construct a new AI agent. As a result, there is a high barrier to entry, as well as a high likelihood of errors (e.g., misconfigurations), long development cycles, and inefficiencies, especially for non-technical users. It would be beneficial if non-technical users were able to construct AI agents in a no-code or low-code environment, for example, using natural language to express their intent.

### SUMMARY

Accordingly, systems, methods, and non-transitory computer-readable media are disclosed for intent-based specification of artificial intelligence (AI) agents using artificial intelligence.

In an embodiment, a method comprises using at least one hardware processor to, by a generation engine: receive an input; determine an intent for a new artificial intelligence (AI) agent, based on the input; determine one or more tasks to be performed by the new AI agent, based on the intent; identify one or more tools to be used by the new AI agent, based on one or both of the intent or the one or more tasks; generate one or more guardrails for the new AI agent, based on one or more of the intent, the one or more tasks, or the one or more tools; and output a recommended AI-agent specification for the new AI agent that specifies the one or more tasks, the one or more tools, and the one or more guardrails.

The input may be received from a user, wherein the method further comprises using the at least one hardware processor to: receive feedback regarding the recommended AI-agent specification from the user; update the recommended AI-agent specification, based on the feedback; and output the updated recommended AI-agent specification.

The method may further comprise using the at least one hardware processor to: receive approval of the recommended AI-agent specification; and in response to the approval, generate a new AI agent, according to the approved AI-agent specification.

Identifying the one or more tools may comprise, for each of the one or more tasks, identifying at least one tool that performs that task.

Determining the intent may comprise: preprocessing the input; applying a machine-learning model to the preprocessed input to produce both an intent classification for the input and one or more named entities, if any, in the input; and structuring the intent classification and the one or more named entities, if any, into a structured intent, wherein the one or more tasks are determined based on the structured intent. The machine-learning model may comprise a Robustly Optimized Bidirectional Encoder Representations from Transformers approach Large (ROBERTa-Large) model.

Determining one or more tasks may comprise: decomposing the intent, represented as a structured intent, into one or more task templates; determine an execution order of the one or more tasks represented by the one or more task templates; generate a set of one or more instructions for each of the one or more tasks; and populating an initial AI-agent specification with the one or more tasks, according to the determined execution order, and the set of one or more instructions for each of the one or more tasks. Generating the one or more instructions for each of the one or more tasks may comprise: generating a prompt that instructs a generative language model to generate a set of instructions for implementing the task; and applying the generative language model to the prompt to produce an output comprising the set of one or more instructions for implementing the task. The method may further comprise using the at least one hardware processor to: determine a value of each of a plurality of personality traits for the new AI agent based on the structured intent; and populate the initial AI-agent specification with the value of each of the plurality of personality traits. The plurality of personality traits may comprise two or more of voice tone, creativity, decisiveness, clarity, confidence, or engagement.

Identifying one or more tools may comprise, for each of the one or more tasks: identify one or more capabilities required by the task; match each of the one or more capabilities to one or more matching tools within a tool registry; and generate a configuration for each of the one or more matching tools.

Generating one or more guardrails may comprise: identify one or more potential risks of the new AI agent, based on capabilities of the new AI agent; select one or more policy templates based on the one or more potential risks; and set a value of each of one or more parameters in each of the one or more policy templates, to define a policy instance that represents a guardrail.

The generation engine may be an AI agent.

The generation engine may implement a real-time chat session, wherein the input is received from a user within the real-time chat session, and wherein the recommended AI-agent specification is output to the user, within the real-time chat session, as a response to the input.

The method may further comprise using the at least one hardware processor to, by the generation engine: receive one or more modifications to the recommended AI-agent specification, wherein at least one of the one or more modifications is to one or more of at least one of the one or more tasks, at least one of the one or more tools, or at least one of the one or more guardrails; and update the recommended AI-agent specification according to the one or more modifications, to produce a final AI-agent specification.

The method may further comprise using the at least one hardware processor to: generate feedback data representing one or more patterns in the one or more modifications; and update the generation engine based on the feedback data.

The method may further comprise using the at least one hardware processor to: generate the new AI agent according to a final AI-agent specification comprising or derived from the recommended AI-agent specification; and deploy the new AI agent to a computing environment. The computing environment may be an integration platform as a service (iPaaS) platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example process for intent-based specification of artificial intelligence (AI) agents using artificial intelligence, according to an embodiment;

FIG. 4 illustrates an example of a process for determining intent for a new AI agent 160, according to an embodiment;

FIG. 5 illustrates an example of a process for determining tasks for a new AI agent, based on intent, according to an embodiment;

FIG. 6 illustrates an example of a process for mapping a structured intent to one or more personality traits, according to an embodiment;

FIG. 7 illustrates an example of a process for determining tools for a new AI agent, according to an embodiment;

FIG. 8 illustrates an example of a process for generating one or more guardrails for a new AI agent, according to an embodiment; and

FIG. 9 illustrates an example of a process for interacting with a user to finalize an AI-agent specification, according to an embodiment.

### DETAILED DESCRIPTION

In an embodiment, systems, methods, and non-transitory computer-readable media are disclosed for intent-based specification of artificial intelligence (AI) agents using artificial intelligence. Embodiments may generate and/or complete a specification of an AI agent, based on a user-specified intent or objective. In particular, embodiments may leverage advanced natural language processing (NLP) and/or machine-learning techniques to interpret a user's intent, and generate a comprehensive AI-agent specification, including intelligent suggestions and recommendations for tasks, tools, guardrails, and/or other relevant components of the AI agent. Embodiments may ensure seamless integration and compatibility between the generated components of the AI agent, while reducing technical barriers and improving accessibility for a wide range of users, including potentially novice or lay users with little to no technical knowledge. Advantageously, in addition to lowering technical barriers, embodiments may simplify and accelerate the creation of new AI agents, reduce the time and effort required to develop new AI agents, reduce or eliminate manual configurations of AI agents, thereby reducing the likelihood of errors, improve the consistency and quality of AI-agent specifications, automatically enforce security, privacy, and ethical standards, continually improve based on user feedback and interactions, and/or enhance scalability and adaptability of automated generation of AI-agent specifications to various domains and use cases.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

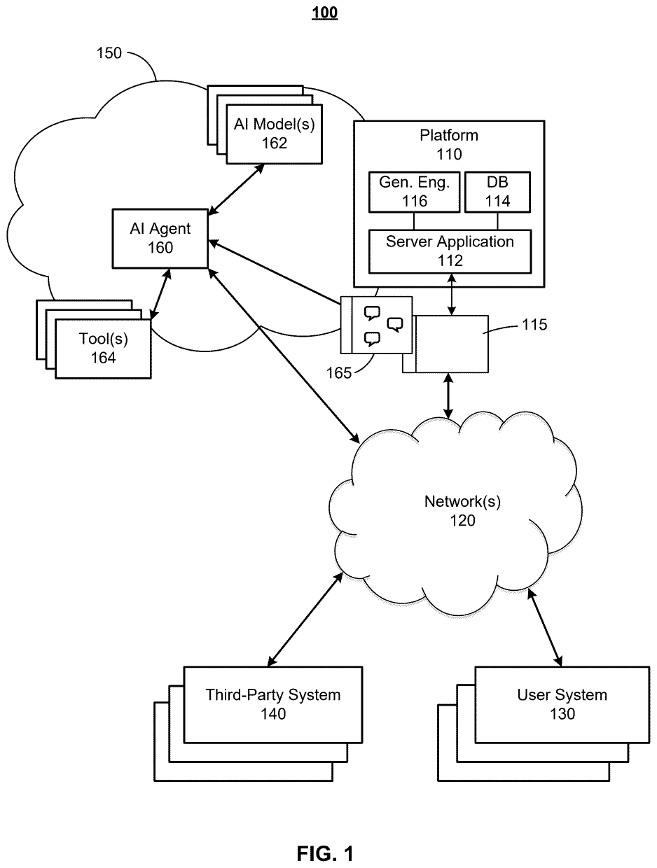

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112, and/or host a database 114 that may store data used by server application 112. Platform 110 may also execute a generation engine 116 (e.g., as part of or in collaboration with server application 112), which utilizes artificial intelligence to specify new AI agents 160, as described in greater detail elsewhere herein. In an embodiment, generation engine 116 is itself an AI agent 160. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a developer or other stakeholder in AI agents 160, who has a user account for accessing server application 112 on platform 110. It should be understood that the user may be anywhere from an expert software engineer, with extensive knowledge of how to construct an AI agent 160, to a business decision-maker, lay person, or other non-technical person, with little to no knowledge of how to construct an AI agent 160. Each user account may be associated with an overarching organizational account for managing software entities, including AI agents 160, being developed by an organization using platform 110.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes.

The user of a user system 130 may authenticate with platform 110 using standard authentication means, to access server application 112 in accordance with permissions or roles of the associated user account. The user may then interact with server application 112 to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through application programming interface.

One or more third-party systems 140 may be communicatively connected to network(s) 120, such that each third-party system 140 may communicate with an integration process in computing environment 150 via an application programming interface. Third-party system 140 may host and/or execute a software application that pushes data to an integration process and/or pulls data from an integration process, via the application programming interface of the integration process. Additionally or alternatively, an integration process and/or AI agent 160 may push data to a software application on third-party system 140 and/or pull data from a software application on third-party system 140, via an application programming interface of the third-party system 140. Thus, third-party system 140 may be a client or consumer of one or more integration processes and/or AI agents 160, a data source for one or more integration processes and/or AI agents 160, and/or the like. As examples, the software application on third-party system 140 may comprise, without limitation, enterprise resource planning (ERP) software, customer relationship management (CRM) software, accounting software, and/or the like.

In an embodiment, the software entities(s) being developed on platform 110 include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeck family of large language models from DeepSeek AI of Hangzhou, Zhejiang, China, any of the Claude family of large language models (e.g., Claude 3 Opus) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLAMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

In some cases, an AI agent 160 may be an AI chat agent. In this case, AI agent 160 may implement a chat interface 165. Chat interface 165 may be comprised or embedded (e.g., as an overlaid chat frame) within user interface 115. Alternatively, chat interface 165 may be separate and distinct from user interface 115. Chat interface 165 may be a graphical user interface, an audio interface, or a combination of graphical and audio user interface (i.e., an audiovisual interface).

### 2. Example Processing System

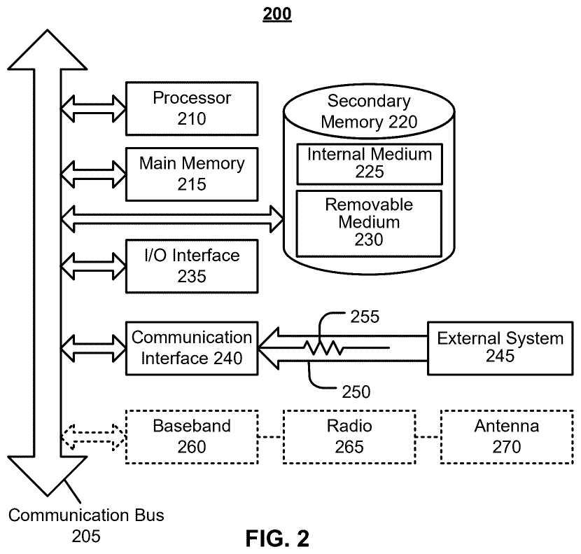

FIG. 2 illustrates an example processing system 200, by which one or more of the processes described herein may be executed, according to an embodiment. For example, system 200 may be used to store and/or execute server application 112, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Overall Process

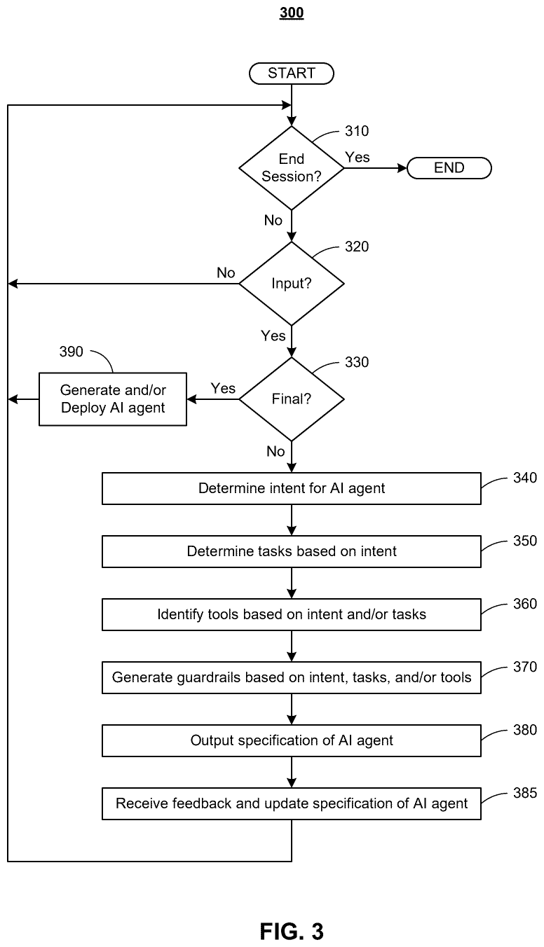

FIG. 3 illustrates an overall process 300 for intent-based specification of artificial intelligence (AI) agents using artificial intelligence, according to an embodiment. Process 300 may be implemented in generation engine 116, which may be a software module of server application 112 or a separate software entity, including potentially, an AI agent 160 that utilizes one or more models 162 and one or more tools 164. Process 300 may be executed whenever a new AI agent 160 needs to be constructed, as may be determined based on one or more inputs within user interface 115 (e.g., to initiate execution of an instance of generation engine 116).

While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

In a contemplated embodiment, a user initiates a session with generation engine 116. The initiation of a new session may be triggered by a user operation, such as the selection of an input by the user within the graphical user interface of user interface 115, the navigation of the user to a particular screen of the graphical user interface, and/or the like. In an embodiment, each session is a real-time chat session, in which a user interacts with generation engine 116 using natural-language inputs, and generation engine 116 responds to the user using natural-language responses. In other words, each of the inputs and the responses comprises a natural-language expression. The natural-language inputs and/or responses may be provided in a textual format and/or audio format (e.g., using a speech-to-text engine to convert the user's speech to text to be processed by generation engine 116, and/or a text-to-speech engine to convert the textual response of generation engine 116 into speech to be output to the user). In some cases, the responses from generation engine 116 may comprise non-textual visual elements, such as images, videos, animations, slides, diagrams, storyboards, charts, graphical user interfaces, and/or other graphical content, potentially in combination with textual visual elements and/or audio elements.

In an embodiment, generation engine 116 is itself an AI agent 160. In this case, generation engine 116 may utilize one or more AI models 162 and/or zero, one, or more tools 164 to process inputs from the user, during the real-time chat session, and produce responses to those inputs during the real-time chat session, within chat interface 165. In other words, generation engine 116 may operate just as any other AI agent 160. Therefore, any description herein of AI agents 160 may equally apply to generation engine 116.

Subprocess 310 may determine whether or not to end the current session. Generation engine 116 may continue to respond to inputs (e.g., from a user), for as long as the session remains active. The end of a session may be triggered by a user operation, such as the selection of an input, by the user, within the graphical user interface of user interface 115 and/or within chat interface 165, a vocal input spoken by the user and received via a microphone of user system 130, the navigation of the user away from the screen (e.g., chat interface 165) in which the interaction with generation engine 116 takes place, the expiration of a timeout period after the most recent user input, and/or the like. When determining to end the session (i.e., “Yes” in subprocess 310), process 300 may end. Otherwise, while not determining to end the session (i.e., “No” in subprocess 310), process 300 may proceed to subprocess 310.

Subprocess 320 may determine whether or not a new input has been received within the session. For example, the user may type a textual input into a textbox within the graphical user interface of user interface 115 and/or chat interface 165 and then select an input to submit the textual input, speak an audio input into an audio interface of user interface 115 and/or chat interface 165 (e.g., which may then be converted to text via a speech-to-text engine), or the like. More generally, the input may be received from a user (e.g., in the context of a real-time chat session), and may comprise or consist of a natural-language expression. Alternatively, the input may be received from another software entity, such a separate AI agent 160, an integration process, a third-party application, or the like. When determining that a new input has been received (i.e., “Yes” in subprocess 320), process 300 may proceed to subprocess 330. Otherwise, while not determining that a new input has been received (i.e., “No” in subprocess 320), process 300 may wait for either the end of the session or a new input.

The first input may express the intent to construct a new AI agent 160. For example, the first input may comprise a natural-language expression that describes the purpose of the new AI agent 160, including, for example, the objective of the new AI agent 160, relevant software entities required for the objective, data to be used to achieve the objective, and/or the like.

Subprocess 330 may determine whether or not there is final specification of the AI agent 160, based on the current input, received in subprocess 320. In particular, subprocess 330 may determine whether or not the current input represents approval of a previously output AI-agent specification. It should be understood that subprocess 330 may not be relevant until at least the second input within a session, since presumably no AI-agent specification will be output until after the first input. However, in an alternative embodiment, a new session could be initialized with a default AI-agent specification, a previously saved AI-agent specification, or other initial AI-agent specification. When determining that the current AI-agent specification is not final (i.e., “No” in subprocess 330), because the current input does not represent approval of the AI-agent specification, process 300 may proceed to subprocess 340. Otherwise, when determining that the current AI-agent specification is final (i.e., “Yes” in subprocess 330), because the current input represents approval of the AI-agent specification, process 300 may proceed to subprocess 390.

Subprocess 340 may determine the intent for the new AI agent 160, based on the current input, received in subprocess 320. The current input may comprise a high-level intent or objective for a new AI agent 160. As discussed in greater detail elsewhere herein, subprocess 340 may utilize one or more natural-language-processing (NLP) techniques to interpret and extract features of the intent, expressed in the input, and output these extracted features in a data structure representing intent. Thus, the output of subprocess 340 may be referred to herein as a “structured intent.”

Subprocess 350 may determine one or more tasks for the new AI agent 160, based on the intent determined in subprocess 340. In particular, as discussed in greater detail elsewhere herein, subprocess 350 may process the structured intent, output by subprocess 340, to determine one or more tasks that will need to be performed by the new AI agent 160 to achieve the intended objective of the new AI agent 160, as represented by the structured intent. To this end, subprocess 350 may leverage pre-trained machine-learning models (e.g., AI models 162) and/or knowledge bases (e.g., tools 164). The output of subprocess 350 is a set (e.g., list) of task(s). Each task may be represented in the output of subprocess 350 as a task template. Essentially, this set of task template(s) specifies a complete set of requirements for the new AI agent 160.

Subprocess 360 may identify one or more tools 164 to be used by the new AI agent 160, based on the structured intent output by subprocess 340 and/or the task(s) determined in subprocess 350. In particular, subprocess 360 may determine at least one tool 164 required to perform or support each of at least a subset of the one or more tasks that were determined in subprocess 350, in accordance with the structured intent. For example, for each task that was output by subprocess 350, subprocess 360 may determine at least one tool 164 that is capable and suitable to perform or support that task. In some cases, subprocess 360 may determine a plurality of tools 164 that perform or support a single task. The output of subprocess 360 may be a set of one or more tools 164 for each of the task(s) determined in subprocess 350, or, in the event that at least on task does not require a tool 164, a set of one or more tools 164 for each of a subset of the task(s), determined in subprocess 350, that do require a tool 164. In other words, each of at least a subset of the task(s) will be assigned a set of one or more tool 164.

Each tool 164 may be represented by a tool definition. A tool definition for a given tool 164 may comprise an identifier of the tool 164, one or more operations from the tool 164, a description (e.g., purpose, capabilities, etc.) of the tool 164 and/or each operation, input and/or output schemas of each operation, a network address (e.g., Uniform Resource Locator (URL), Internet Protocol (IP) address, etc.) of the tool 164, a security protocol for tool 164, and/or the like. The tool definitions for a plurality of tools 164, available to AI agents 160 within computing environment 150 and/or otherwise available via platform 110, may be stored in a tool registry (e.g., in database 114). It should be understood that a given tool 164 may be local to or remote from the computing environment 150 in which the new AI agent 160 will execute.

A tool 164 may be identified as performing or supporting a given task when the tool definition for that tool 164 matches the task template for a task, which may comprise or consist of a description of the task. This matching between the tool definitions and the task templates, within the tool registry, may be performed using any suitable technique, including, without limitation, collaborative filtering, content-based filtering, vector similarity searching, keyword-based searching, pattern matching or classification, semantic analysis, complex multi-step reasoning, deep-learning classification (e.g., using a deep-learning artificial neural network), and/or the like.

In collaborative filtering, a tool 164 is identified as relevant to a task when it or a similar tool 164 was used historically to perform the same or similar task. Collaborative filtering may utilize historical data for a plurality of other AI agents 160, executing in computing environment 150 and/or external to computing environment 150, including descriptions of the tasks that those AI agents 160 performed and the tools 164, within the tool registry, that the AI agents 160 used to perform those tasks. In an embodiment in which platform 110 represents an iPaaS platform, there may be a massive amount of available historical data, collected from all of the AI agents 160 deployed by all users of the iPaaS platform and stored in database 114. Subprocess 360 may, for each task determined in subprocess 350, identify the same tool(s) 164 that were used, in historical AI agents 160, for that task or a similar task, as defined by their respective task templates.

In content-based filtering, a tool 164 is identified as relevant to a task when its tool definition matches the task template. For example, a feature vector, comprising the value of a plurality of features, may be extracted from the task template, and compared with feature vectors that were extracted from tool definitions in the tool registry. Subprocess 360 may, for each task determined in subprocess 350, identify the tool(s) 164 whose feature vectors are most similar to the feature vector representing that task.

In a vector similarity search, a given task template may be converted into an input vector embedding within a multi-dimensional vector space. The vector space may include one-hundred or more dimensions, and the input vector embedding may comprise a vector of real numbers, with each real number representing a position of the current task template within one dimension of the vector space. The input vector embedding may be compared to pre-computed vector embeddings that each represents one of a plurality of tools 164 (e.g., as defined by their respective tool definitions) in the tool registry, according to a similarity metric. The similarity metric may represent a distance, between the input vector embedding and a given pre-computed vector embedding, such as Euclidean distance, Manhattan distance, cosine distance, Hamming distance, Minkowski distance, Chebyshev distance, Jaccard distance, Haversine distance, Sorensen-Dice distance, or the like. The tool 164 that is represented by the pre-computed vector embedding that is the shortest distance from the input vector embedding and/or any tool 164 that is represented by a pre-computed vector embedding that is within a threshold distance from the input vector embedding, in terms of the similarity metric, may be identified as relevant to the task, represented by the input vector embedding. Examples of vector databases that may be used for the vector similarity search include, without limitation, Pinecone from Pinecone of San Francisco, California, Weaviate from Wecaviate of Amsterdam, Netherlands, Qdrant from Qdrant of Berlin, Germany, Milvus from The Milvus Project of Redwood Shores, California, Chroma from Chroma of San Francisco, California, Vespa from Vespa.ai of Trondheim, Norway, Vald from Vald of Tokyo, Japan, pgvector from the pgvector open-source project associated with the PostgreSQL community, and MongoDB Atlas Vector Search from MongoDB Inc. of New York, New York, Facebook AI Similarity Search (FAISS) from Meta of Menlo Park, California, United States, Annoy from Spotify of Stockholm, Sweden, Scannable Nearest Neighbors (ScaNN) from Google of Mountain View, California, United States, the Non-Metric Space Library (NMSLIB) from the NMSLIB open-source project associated with the Non-Metric Space Library community, and the Hierarchical Navigable Small World library (HNSWlib) from the HNSWlib open-source project associated with the Hierarchical Navigable Small World graphs community.

In a keyword-based search, input keywords from a given task template may be matched to keywords associated within tool definitions of each of the plurality of tools 164 in the tool repository, using any suitable matching algorithm. The tool 164 that is associated with keywords that most closely match the input keywords and/or any tool 164 that is associated with keywords, for which a match metric to the input keywords satisfies a threshold, may be identified as relevant.

In rule-based pattern matching, one or more input patterns may be derived from a given task template and matched to one or more patterns associated with each of the plurality of tools 164 in the tool registry. A pattern may comprise a regular expression (e.g., representing arrangements of characters and/or keywords), a set of measured values, and/or the like. The tool 164 that is associated with a pattern that matches the input pattern and/or any tool 164 that is associated with a pattern, for which a match metric to the input pattern satisfies a threshold, may be identified as relevant.

Pattern classification may go beyond rule-based pattern matching, to identify more complex or nuanced patterns, which may not be apparent or discoverable by human observation. A pattern-based classifier may extract a plurality of input features, representing a pattern, from the task template, and utilize a machine-learning classifier (e.g., an artificial neural network) to classify the plurality of input features into one of a plurality of classifications. Each of the plurality of classifications may represent one of the tools 164 or a group (e.g., type, category, etc.) of tools 164 within the tool registry. The machine-learning classifier may be trained using supervised learning (e.g., using a training dataset comprising labeled feature vectors) or unsupervised learning (e.g., by grouping feature vectors into clusters with prior class labels).

Semantic analysis may utilize specialized models to understand the task, and match that task, as represented by a task template, to one or more relevant tools 164. Examples of suitable natural language processing (NLP) libraries for semantic analysis include, without limitation, the Natural Language Toolkit (NLTK) from the NLTK Project of the University of Pennsylvania in Philadelphia, Pennsylvania, spaCy from Explosion of Berlin, Germany, Gensim from the RaRe Technologies open-source community originally based in Prague, Czech Republic, and Transformers from Hugging Face of Paris, France and New York, New York. Examples of knowledge graphs and semantic web tools include, without limitation, Neo4j from Neo4j, Inc. of San Mateo, California, Amazon Neptune from Amazon Web Services (AWS) of Seattle, Washington, ArangoDB from ArangoDB GmbH of Cologne, Germany, rdflib from the rdflib open-source project associated with the Python community, and Apache Jena from The Apache Software Foundation of Forest Hill, Maryland.

Complex multi-step reasoning involves breaking down the identification of relevant tools 164 into smaller, sequential steps. For example, one or more AI models (e.g., AI model 162), such as generative language model(s), may be applied over multiple steps, with the output of one application of an AI model being provided as or used to derive the input to another application of an AI model, until a final conclusion is made about the relevance of one or more tools 164 to the task description. In other words, a generative language model may generate a series of preliminary outputs, in series and/or in parallel, that are chained, combined, or otherwise aggregated to generate a final output, identifying one or more relevant tools 164.

Deep-learning classification involves the application of a deep-learning artificial neural network to a given task template. In particular, a deep-learning classifier may extract a plurality of input features from the task template, and utilize a deep-learning artificial neural network to classify the plurality of input features into one of a plurality of classifications. Each of the plurality of classifications may represent one of the tools 164 or a group (e.g., type, category, etc.) of tools 164 within the tool registry. The deep-learning classifier may be trained, using supervised learning with a training dataset that comprises feature vectors, representing tasks, that are each labeled with the correct classification, representing a tool 164 or group of tools 164 within the tool registry. As is well-known in the art, a deep-learning artificial neural network is a multi-layered artificial neural network, typically with a plurality of hidden layers.

Subprocess 370 may generate one or more guardrails for the new AI agent 160, based on the intent, determined in subprocess 340, the task(s), determined in subprocess 350, and/or the tool(s), identified in subprocess 360. It should be understood that the task(s) and tool(s) represent the capabilities of the new AI agent 160. The guardrail(s) represent a framework of policies, controls, and/or mechanisms that govern how the new AI agent 160 can interact with its environment, including users, other software entities, AI model(s) 162, and/or tool(s) 164. Collectively, the guardrail(s) ensure that the new AI agent 160 will operate safely, reliably, ethically, and/or effectively, within the bounds of organizational policies, regulatory requirements, and/or the like.

Each guardrail may be a predefined limit or control that guides and constrains the outputs or actions of the new AI agent 160, to prevent harmful, unsafe, unethical, or unintended behavior. Types of guardrails include, without limitation, behavioral constraints that restrict what the new AI agent 160 can or cannot do, output filtering which blocks or modifies outputs that contain toxic, biased, or harmful content, safety, privacy, and ethical boundaries that ensure the new AI agent 160 does not make unethical choices even if they are optimal for a given objective, domain constraints which limit the new AI agent 160 to a specific domain or context, human-in-the-loop checks which require human approval before certain decisions of the new AI agent 160 are executed, fallback strategies (e.g., escalate to a human, default to a safe response, etc.) that define what the new AI agent 160 should do when it is unsure about a response, and the like.

Subprocess 370 may utilize any suitable mechanism for generating the guardrails. For example, subprocess 370 could use collaborative filtering to identify guardrails that are associated with the same or similar tasks as were output by subprocess 350 and/or the same or similar tools 164 as were output by subprocess 360, from historical data for a plurality of other AI agents 160. As another example, subprocess 370 may utilize a generative language model (e.g., AI model 162 in the event that generation engine 116 is an AI agent 160), such as a large language model, to generate the guardrails. In this case, subprocess 370 may generate a prompt that describes task(s), determined by subprocess 350, and/or too(s) 164, identified by subprocess 360, and instructs the generative language model to determine any applicable guardrails that should be used to ensure acceptable behavior of an AI agent 160 performing these tasks and/or utilizing these tools. Subprocess 370 may then apply the generative language model to this prompt, to produce an output comprising the one or more guardrails.

Subprocess 380 may output the AI-agent specification for the new AI agent 160. The AI-agent specification may specify the task(s), determined in subprocess 350, the tool(s) determined in subprocess 360, and/or the guardrail(s) determined in subprocess 370. Outputting the AI-agent specification may comprise displaying a representation of the AI-agent specification within the user interface of generation engine 116. In an embodiment in which generation engine 116 is itself an AI agent 160, the representation of the AI-agent specification may be displayed in chat interface 165, during a real-time chat session with generation engine 116.

The user may interact with the representation of the AI-agent specification in an intuitive manner, to review, modify, and approve the AI-agent specification. As will be discussed in greater detail elsewhere herein, the representation of the AI-agent specification (e.g., displayed in the graphical user interface) may comprise editable and/or selectable options for one or more of the task(s), tool(s), and/or guardrail(s). Thus, the user may edit and/or select the recommended task(s), tool(s), and/or guardrail(s), remove task(s), tool(s), and/or guardrail(s), add task(s), tool(s), and/or guardrail(s), delete task(s), tool(s), and/or guardrail(s), and/or otherwise modify the AI-agent specification, as needed or desired. These modifications may be performed via respective inputs (e.g., within chat interface 165, the graphical user interface of user interface 115, or other graphical user interface). Modifications to the AI-agent specification and/or approval or rejection of the AI-agent specification represent feedback, which may be used to fine-tune generation engine 116 (e.g., the machine-learning model(s) and/or rules used by generation engine 116), for continuous improvement over time.

Subprocess 385 may receive any feedback, regarding the AI-agent specification that was output as a recommendation by subprocess 380, from the user. As discussed above, this feedback may comprise modifications to the tasks, tools 164, and/or guardrails, and/or other components of the AI-agent specification. Subprocess 385 may update the recommended AI-agent specification, based on the feedback, and output the updated recommended AI-agent specification. This process of receiving feedback and updating the AI-agent specification may continue for as long as needed to obtain the final AI-agent specification. At a high level, subprocess 385 receives one or more modifications to the recommended AI-agent specification (e.g., to at least one task, tool, and/or guardrail), and updates the recommended AI-agent specification according to the modification(s), to produce a final AI-agent specification. In addition, subprocess 385 may generate feedback data, representing one or more patterns in the modification(s), from the user feedback, and update generation engine 116 based on the feedback data.

Subprocess 390 may generate and/or deploy the new AI agent 160, for example, to computing environment 150. In particular, in response to approval of the AI-agent specification (i.e., “Yes” in subprocess 330), subprocess 390 may generate a new AI agent 160, according to the approved final AI-agent specification, which may comprise, consist, or be derived from the recommend AI-agent specification that was output in subprocess 380. Generation engine 116 may generate the new AI agent 160 by combining a plurality of pre-built (e.g., stored in database 114) or dynamically built (e.g., by a generative coding model) software components, according to an agent template. The software components may comprise processing logic, one or more pre-built AI models 162, a connector or adapter for each tool 164 within the AI-agent specification, which is configured to establish a connection with that tool 164, a protocol client (e.g., Model Context Protocol (MCP) client), and/or the like. Once the new AI agent 160 has been generated, subprocess 390 may automatically (i.e., with no user involvement), semi-automatically (e.g., with user approval or confirmation), or manually (e.g., in response to a user operation) deploy the newly generated AI agent 160 to computing environment 150. As mentioned elsewhere herein, computing environment 150 may be an iPaaS platform.

### 4. Intent Determination

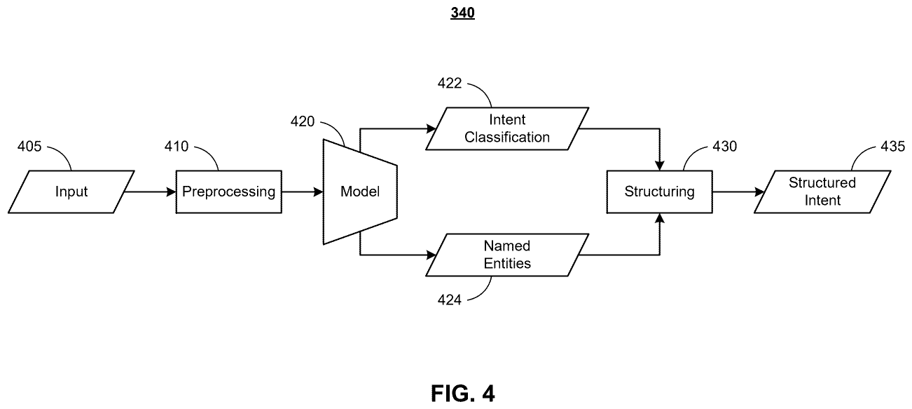

FIG. 4 illustrates an example of subprocess 340 for determining intent for a new AI agent 160, according to an embodiment. At a high level, subprocess 340 transforms natural-language expressions of users' intent into structured representations of that intent. Subprocess 340 may employ a staged approach that comprises preprocessing 410, a model 420, and structuring 430, which may all be implemented as software modules. While subprocess 340 is illustrated with a certain arrangement and ordering of components, subprocess 340 may be implemented with fewer, more, or different components and a different arrangement and/or ordering of components.

Initially, input 405 (e.g., received in subprocess 320) may be preprocessed by preprocessing 410. It should be understood that input 405 may be a textual input, comprising, for example, the text that a user typed into a chat frame or that was converted from speech by a speech-to-text engine. Preprocessing 410 may standardize the text input 405 through normalization and tokenization. Normalization converts text input 405 into a consistent, standard format, and tokenization divides the text input 405 into units called “tokens” for further processing. The output of preprocessing 410 is a set of tokens representing input 405.

Next, model 420 may be applied to the preprocessed input 405, to produce both an intent classification 422 for input 405 and one or more named entities 424, if any, in input 405. In particular, model 420 is applied to the set of tokens, output by preprocessing 410. Model 420 may be a machine-learning model (e.g., an AI model 162 in an embodiment in which generation module 116 is an AI agent 160). In an embodiment, a single unified model 420 handles the core natural-language-processing (NLP) tasks. Model 420 may take the set of tokens as input, and output both the intent classification 422, from a plurality of possible intent classifications, and one or more named entities 424, if any.

One suitable example of model 420 is the Robustly Optimized BERT approach large (ROBERTa-Large) model. The base ROBERTa model is described in “ROBERTa: A Robustly Optimized BERT Pretraining Approachm” by Liu et al., which is hereby incorporated herein by reference as if set forth in full. ROBERTa is an optimized and retrained version of the Bidirectional Encoder Representations from Transformers (BERT) model, developed by Google AI. The ROBERTa-Large model is a larger version of the ROBERTA model, which has been trained on more data and with more parameters. To produce model 420, the ROBERTa-Large model may be fine-tuned for intent classification and named entity recognition. In an embodiment, the ROBERTa-Large model is applied to the set of tokens, in a first pass, to classify the intent, expressed within input 405, into one of a plurality of classifications, and output that intent classification 422 (e.g., the intent classification with the highest confidence), and then, in a second pass, to output any named entities 424 within input 405. In an alternative embodiment, the architecture of the ROBERTa-Large model may be modified to create a multi-task model that simultaneously performs both intent classification and named entity recognition. In this case, the ROBERTa-Large encoder may convert the tokens into token embeddings, and then a first head may process the token embeddings for intent classification, while a second head simultaneously processes the token embeddings for named entity recognition. It should be understood that the ROBERTa-Large model is simply one example, and that, in alternative embodiments, a different model may be used, including the BERT model or another model derived from or based on the BERT model.

Structuring module 430 may structure intent classification 422 and any named entities 424 into structured intent 435, using rule-based post-processing. Structured intent 435 may comprise a predefined data structure that structuring module 430 populates with the intent classification 422 and any named entities 424 for a given input 405. Thus, structured intent 435 is a formal, machine-readable representation of intent that may be easily passed as an input to subsequent subprocesses (e.g., subprocesses 350, 360, and/or 370).

For the purposes of an example, assume that input 405 consists of the following natural-language expression: “I need an agent that can monitor my GitHub repositories, alert me when new issues are created, and automatically tag them based on their content.” In this case, model 420 may output the following intent classification 422 and named entities 424:

```
{
  “intent_type”: “monitoring_and_notification”,
  “confidence”: 0.92,
  “entities”: {
    “platforms”: [{“name”: “GitHub”, “confidence”: 0.98}],
    “objects”: [{“name”: “repositories”, “confidence”: 0.95},
    {“name”: “issues”, “confidence”: 0.97}],
    “actions”: [
      {“verb”: “monitor”, “object”: “repositories”,
      “confidence”: 0.94},
      {“verb”: “alert”, “object”: “user”, “trigger”: “new
      issues”, “confidence”: 0.91},
      {“verb”: “tag”, “object”: “issues”, “modifier”:
      “automatically”, “basis”: “content”, “confidence”: 0.89}
    ]
  }
}
```

Continuing this example, structuring module 430 may output the following structured intent 435:

```
{
  “primary_intent”: “monitoring_notification”,
  “platforms”: [“GitHub”],
  “workflow”: {
    “trigger”: {“type”: “event”, “source”: “GitHub”, “event”:
    “issue_created”},
    “actions”: [
      {“type”: “analyze”, “target”: “issue_content”},
      {“type”: “tag”, “target”: “issue”, “basis”:
      “content_analysis”},
      {“type”: “notify”, “target”: “user”, “content”:
      “issue_details”}
    ]
  },
  “confidence_score”: 0.87
}
```

### 5. Task Determination

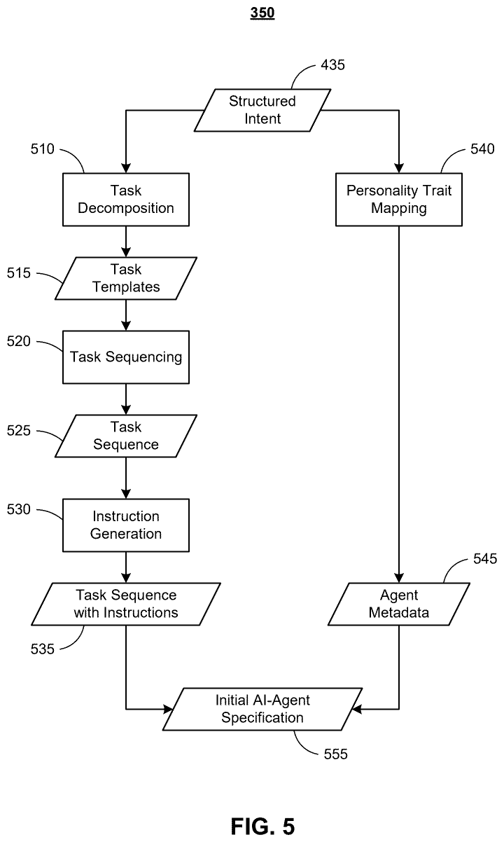

FIG. 5 illustrates an example of subprocess 350 for determining tasks for a new AI agent 160, based on intent, according to an embodiment. At a high level, subprocess 350 transforms the structured intent 435, output by subprocess 340, into an initial AI-agent specification 555. Subprocess 350 may employ a first thread that comprises task decomposition 510, task sequencing 520, and instruction generation 530, and a second thread that comprises personality trait mapping 540, which may all be implemented as software modules. The first and second threads may be executed in parallel or serially. While subprocess 350 is illustrated with a certain arrangement and ordering of components, subprocess 350 may be implemented with fewer, more, or different components and a different arrangement and/or ordering of components.

To start the first thread, task decomposition 510 may be performed on structured intent 435. Task decomposition 510 decomposes the intent, represented as structured intent 435, into a set of logical tasks, and particularly, into one or more task templates 515. For example, each task template 515 may represent a logical task that accomplishes some aspect of the intent embodied in structured intent 435. Each task template 515 may comprise or consist of a type of the respective task, a description of the respective task, an importance of the respective task (e.g., low, medium, or high), a frequency of the respective task (e.g., continuous, on demand, etc.), dependencies of the respective task (e.g., another task or type of task on which the respective task depends), and/or the like. Thus, structured intent 435 may be matched to one or more of a plurality of available task templates 515, which each identifies at least one task required for the new AI agent 160. Matching of structured intent 435 to a task template 515 may be performed in any suitable manner, including, without limitation, rule-based matching, keyword matching, pattern matching, and/or the like. Thus, the output of task decomposition 510 may be one or more task templates 515, that each identifies and represents one or more tasks.

Continuing the first thread, task sequencing 520 may determine an execution order of the task(s), represented by the task template(s) 515, output by task decomposition 510, based on dependency analysis. For example, task sequencing 520 may determine which tasks depend on another task, based on the dependencies, if any, in the task template(s) 520, and ensure that any task, upon which another task depends, is executed before that other task. This dependency analysis may be performed using a directed graph, in which tasks are represented as nodes and dependencies are represented as unidirectional edges. The output of task sequencing 520 may be a task sequence 525 of task templates 515 in the determined execution order.

Continuing with the specific example of structured intent 435 above, task sequencing 520 may output the following task sequence 525:

```
{
  “tasks”: [
    {
      “task_type”: “monitoring”,
      “description”: “Monitor GitHub repositories for new
      issues”,
      “importance”: “high”,
      “frequency”: “continuous”
    },
    {
      “task_type”: “analysis”,
      “description”: “Analyze issue content for tagging”,
      “importance”: “medium”,
      “dependencies”: [“monitoring”]
    },
    {
      “task_type”: “action”,
      “description”: “Apply tags to GitHub issues”,
      “importance”: “medium”,
      “dependencies”: [“analysis”]
    },
    {
      “task_type”: “notification”,
      “description”: “Notify user about new tagged issues”,
      “importance”: “high”,
      “dependencies”: [“action”]
    }
  ]
}
```

Continuing the first thread, instruction generation 530 may generate a set of one or more instructions for each task represented in task sequence 525 of task templates 515. Instruction generation 530 may utilize a machine-learning model, such as a generative language model, which may be a large language model, to generate the instruction(s) for each task. In particular, instruction generation 530 may, for each task template 515 in the task sequence 525, generate a prompt that instructs the generative language model to generate a set of instructions for implementing the task, represented by that task template 515, potentially with additional information (e.g., name, objective, description, etc.) and apply the generative language model to this prompt, to produce an output comprising the set of one or more instructions for implementing the task, potentially with additional information. Instruction generation 530 may utilize few-shot prompting, whereby the prompt comprises a small number of examples, referred to as “shots,” to guide the response. The output of instruction generation 530 may be task sequence with instructions 535. Task sequence with instructions 535 may comprise, in execution order, for each task that is represented by a task template 515 in task sequence 525, a name of the task, an objective of the task, a set of one or more instructions for completing the task, and/or the like.

Continuing with the specific example above, instruction generation 530 may output the following task sequence with instructions 535:

```
{
  “tasks”: [
    {
      “name”: “Monitor GitHub Repositories”,
      “objective”: “Check for new issues in specified
      repositories”,
      “instructions”: [
        “Periodically check the user's GitHub repositories for
        new issues”,
        “Compare with previously seen issues to identify new
        ones”,
        “Capture full issue details including title, body, and
        metadata”
      ]
    },
    {
      “name”: “Analyze Issue Content”,
      “objective”: “Determine appropriate tags based on issue
      content”,
      “instructions”: [
        “Extract the title and description of the new issue”,
        “Analyze the text to identify key topics and
        technologies mentioned”,
        “Determine appropriate tags based on content analysis”
      ]
    },
    {
      “name”: “Apply Tags to Issues”,
      “objective”: “Add determined tags to GitHub issues”,
      “instructions”: [
        “Use the GitHub API to add the recommended tags to the
        issue”,
        “Verify successful application of tags”,
        “Record which tags were applied to which issues”
      ]
    },
    {
      “name”: “Notify User”,
      “objective”: “Alert user about new tagged issues”,
      “instructions”: [
        “Create a notification with issue details and applied
        tags”,
        “Include direct links to the GitHub issues”,
        “Deliver notification to the user”
      ]
    }
  ]
}
```

In the second thread, personality trait mapping 540 may map the intent, represented as structured intent 435, into agent metadata 545. Agent metadata 545 may comprise one or more personality traits for the new AI agent 160, as well as a name of the new AI agent 160, a description of the new AI agent 160, and/or the like. The personality trait(s) may be determined using a rule-based approach with domain-specific heuristics.

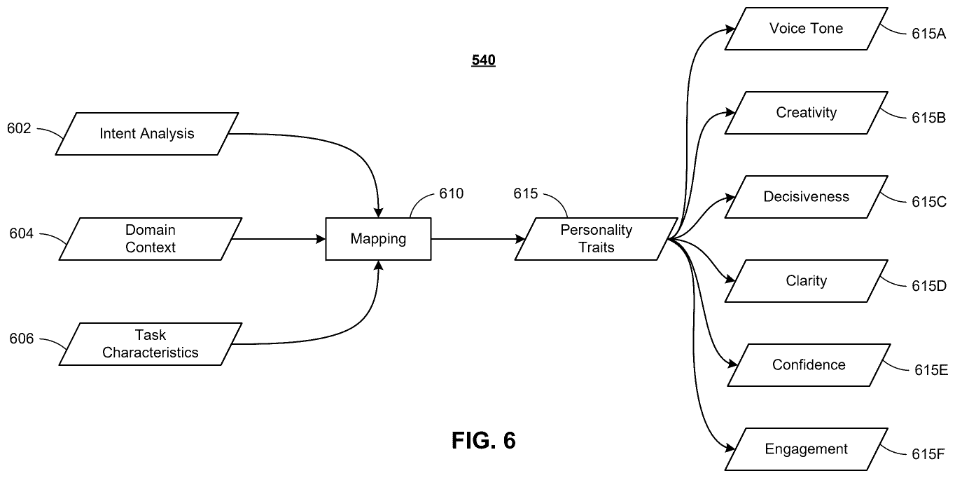

FIG. 6 illustrates an example of subprocess 540 for mapping structured intent 435 to one or more personality traits, according to an embodiment. While subprocess 540 is illustrated with a certain arrangement and ordering of components, subprocess 540 may be implemented with fewer, more, or different components and a different arrangement and/or ordering of components.

Intent analysis 602, domain context 604, and/or task characteristics 606 may be input into mapping 610. Intent analysis 602 may comprise an analytic result of structured intent 435. Domain context 604 may define the intended domain and context in which the new AI agent 160 will operate. Task characteristics 606 may be extracted from the task template(s) 515, output by task decomposition 510 or task sequencing 520. Mapping 610 may map intent analysis 602, domain context 604, and/or task characteristics 606 to values for one or more, and preferably a plurality of, personality traits 615.

In an embodiment, mapping 610 determines the value of each of a plurality of personality traits 615, based on structured intent 435 and/or task template(s) 515. Examples of personality traits 615 include, without limitation, voice tone 615A, creativity 615B, decisiveness 615C, clarity 615D, confidence 615E, and/or engagement 615F. It should be understood that embodiments may include all of these personality traits 615, some subset of these personality traits 615, with or without additional personality traits 615, or none of these personality traits 615, depending on the applicable design factors.

Voice tone 615A refers to the style and manner of communication that the new AI agent 160 will utilize. The value of voice tone 615A may be selected based on the formality of the use case and/or audience expectations. The possible values of voice tone 615A may comprise or consist of professional, casual, technical, friendly, authoritative, and/or supportive.

Creativity 615B refers to the ability of the new AI agent 160 to generate ideas or artifacts that are new, surprising, or valuable, and reflects the new AI agent's approach to open-ended tasks. The value of creativity 615B may be an integer or real number within the range of zero to one hundred (0-100), in which low values of zero to thirty (0-30) represent highly structured and predictable responses, medium values of forty to seventy (40-70) represent a balanced approach with moderate variation, and high values of eighty to one hundred (80-100) represent more diverse and innovative responses.

Decisiveness 615C refers to the ability of the new AI agent 160 to make timely and confident decisions based on available information, even in the presence of uncertainty, incomplete data, or conflicting options, and governs how the new AI agent 160 handles ambiguity and options. The value of decisiveness 615C may be an integer or real number within the range of zero to one hundred (0-100), in which low values result in the new AI agent 160 seeking user input for multiple options, and high values result in the new AI agent 160 making clear recommendations and proceeding confidently.

Clarity 615D refers to the ability of the new AI agent 160 to communicate information, decisions, or instructions in a precise, unambiguous, and easily understandable manner to users or other systems, and determines the level of detail and explanation provided by the new AI agent 160. The value of clarity 615D may be an integer or real number within the range of zero to one hundred (0-100), in which low values result in the new AI agent 160 providing concise, minimal explanations, and high values result in the new AI agent 160 providing thorough explanations with supporting details.

Confidence 615E refers to the new AI agent's internal estimate of certainty or reliability in its predictions, decisions, or outputs, and reflects how sure the new AI agent 160 is about the correctness of its actions or responses. The value of confidence 615E, which may control how the new AI agent 160 expresses certainty, may be an integer or real number within the range of zero to one hundred (0-100), in which low values result in the new AI agent 160 using hedged language and acknowledging its limitations, and high values result in the new AI agent 160 using an authoritative tone and emphasizing its expertise.

Engagement 615F refers to the ability of the new AI agent 160 to maintain a meaningful, responsive, and interactive relationship with the user or environment over time, and reflects how effectively the new AI agent 160 sustains attention, responds appropriately, and adapts to user intent or context. The value of engagement 615F, which may determine the proactive and follow-up behavior of the new AI agent 160, may be an integer or real number within the range of zero to one hundred (0-100), in which low values result in the new AI agent 160 responding to direct queries only, and high values result in the new AI agent 160 suggesting next steps and asking follow-up questions.

As an example, the following values of personality traits 615 produce a Salesforce case management agent that communicates in a formal, business-appropriate manner, with creative approaches to case categorization and definitive recommendations on case types, while offering highly detailed explanations and instructions, expressing strong confidence in its classifications, and proactively engaging the user with follow-up suggestions:

```
“personality_traits”: {
  “voice_tone”: “Professional”,
  “creativity”: 80,
  “decisiveness”: 90,
  “clarity”: 100,
  “confidence”: 100,
  “engagement”: 100
}
```

In addition to personality traits 615, agent metadata 545 may comprise additional information about the new AI agent 160, including, without limitation, the objective, name, and/or description of the new AI agent 160, conversation starters for the new AI agent 160, and/or the like. Continuing with the example above, this additional information may be:

```
{
  “objective”: “Monitor GitHub repositories for new issues and
  automatically tag them based on content”,
  “name”: “GitHubIssueMonitor”,
  “description”: “This agent monitors your GitHub repositories
  for new issues, automatically analyzes their content to apply
  appropriate tags, and notifies you about these new issues.”,
  “conversation_starters”: [
    “Check for new GitHub issues”,
    “Show me recent repository activity”,
    “Have any new issues been tagged today?”
  ]
}
```

Subprocess 350 may combine the task sequence with instructions 535, output by the first thread, with the agent metadata 545, output by the second thread, into an initial AI-agent specification 555. In other words, initial AI-agent specification 555 may be populated with the task sequence with instructions 535 and agent metadata 545. At this point, initial AI-agent specification 555 represents a partial AI-agent specification, in which the tasks and metadata are specified, but in which the tools 164 and guardrails have not yet been specified. It should be understood that any tools 164 and guardrails will be subsequently populated into this initial AI-agent specification 555 by subprocesses 360 and 370, respectively, to produce a complete AI-agent specification.

### 6. Tool Identification

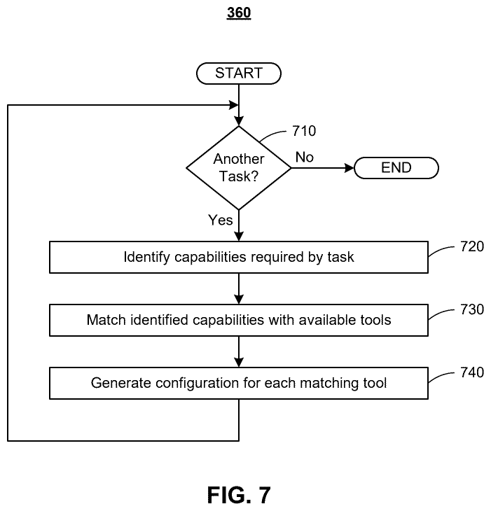

FIG. 7 illustrates an example of subprocess 360 for determining tools 164 for a new AI agent 160, according to an embodiment. At a high level, subprocess 360 matches each task, determined in subprocess 350, with one or more tools 164 from a tool registry, representing a library of all tools 164 available within computing environment 150 and/or on platform 110. While subprocess 360 is illustrated with a certain arrangement and ordering of subprocesses, subprocess 360 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 710 may determine whether or not another task, output by subprocess 350, remains to be considered. Essentially, subprocess 360 will iterate through each task that was output by subprocess 350, and for each of the one or more tasks output by subprocess 350, perform subprocesses 720-740. When another task remains to be considered (i.e., “Yes” in subprocess 710), subprocess 360 may select the next task and proceed to subprocess 720. Otherwise, when no more tasks remain to be considered (i.e., “No” in subprocess 710), subprocess 360 may end.

Subprocess 720 may identify one or more capabilities that are required by the selected task. In particular, subprocess 720 may perform capability analysis to identify the functional capabilities needed for the selected task.

Continuing the example from the preceding section, an example task may be represented as:

```
{
  “name”: “Monitor GitHub Repositories”,
  “objective”: “Check for new issues in specified repositories”,
  “instructions”: [
    “Periodically check the user's GitHub repositories for new
    issues”,
    “Compare with previously seen issues to identify new ones”,
    “Capture full issue details including title, body, and
    metadata”
  ]
}
```

Given this example task, the capabilities required by the task, as identified by subprocess 720, may be:

```
{
  “required_capabilities”: [
    {“type”: “api_integration”, “platform”: “GitHub”,
    “operation”: “read”, “confidence”: 0.95},
    {“type”: “data_storage”, “purpose”: “state_management”,
    “confidence”: 0.87},
    {“type”: “event_detection”, “event_type”: “new_content”,
    “confidence”: 0.91}
  ]
}
```

Subprocess 730 may match each identified capability with matching tools 164 that are available within the tool registry. For example, subprocess 730 may perform a semantic analysis or search, as described elsewhere herein. In an embodiment, the semantic search is performed using Sentence-BERT embeddings to match an embedding, representing a capability, to embeddings representing tools 164 within the tool registry. The tool that is represented by an embedding that is most similar to the embedding for a capability (e.g., for which a similarity metric is highest) and/or any tool 164 that is represented by an embedding that is similar (e.g., for which the similarity metric satisfies a predefined threshold) to the embedding for the capability, may be identified as a matching tool 164. Sentence-BERT is a modification of the pre-trained BERT network that uses Siamese and triplet network structures to create sentence embeddings that can be compared using cosine similarity as the similarity metric. It should be understood that any other suitable embedding technique may be used, instead of Sentence-BERT.

Given the example capabilities above, the matching tools 164, identified by subprocess 730, may be:

```
{
  “candidate_tools”: [
    {
      “id”: “github-api-connector”,
      “name”: “GitHub API Connector”,
      “match_score”: 0.94,
      “capabilities_covered”: [“api_integration”,
      “event_detection”]
    },
    {
      “id”: “state-manager”,
      “name”: “Agent State Manager”,
      “match_score”: 0.89,
      “capabilities_covered”: [“data_storage”]
    },
    {
      “id”: “webhook-handler”,
      “name”: “GitHub Webhook Handler”,
      “match_score”: 0.82,
      “capabilities_covered”: [“api_integration”,
      “event_detection”]
    }
  ]
}
```

Subprocess 740 may generate a configuration for each tool 164 that was matched in subprocess 730. For example, subprocess 740 may utilize rule-based templates to determine an appropriate configuration for each matching tool 164. Each template may define a plurality of parameters that need to be specified, and a set of rules may determine the value of each of the plurality of parameters, based on the selected task, the determined intent (e.g., structured intent 435), the current input (e.g., input 405), the current context of the session, historical values of the parameter for the same user and/or different users, and/or the like.

Continuing the example above, the configurations, output by subprocess 740, for the final set of matching tools 164 may be represented as:

```
{
  “tools”: [
    {
      “id”: “github-api-connector”,
      “type”: “OpenAPI”,
      “description”: “GitHub Issues API connector”,
      “requires_approval”: false,
      “response_passthrough”: false,
      “configuration”: {
        “endpoints”: [“/repos/ {owner}/ {repo} / issues”],
        “polling_interval”: “15m”
      }
    },
    {
      “id”: “state-manager”,
      “type”: “Function”,
      “description”: “Maintains record of previously seen
      issues”,
      “requires_approval”: false,
      “configuration”: {
        “storage_type”: “persistent”
      }
    }
  ]
}
```

### 7. Guardrail Generation

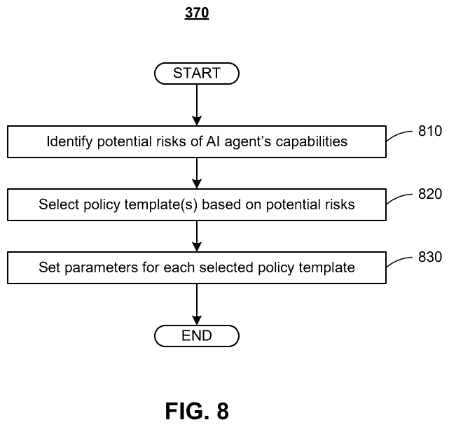

FIG. 8 illustrates an example of subprocess 370 for generating one or more guardrails for a new AI agent 160, according to an embodiment. At a high level, subprocess 370 generates one or more guardrails for the new AI agent 160, based on structured intent 435, the task(s) determined by subprocess 350, and/or the tool(s) identified by subprocess 360. Each guardrail represents a constraint or limitation on the behavior of the new AI agent 160, given the new AI agent's intended functionality. In an embodiment, subprocess 370 utilizes a rule-based approach, such that no machine-learning models are required by subprocess 370. While subprocess 370 is illustrated with a certain arrangement and ordering of subprocesses, subprocess 370 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, subprocess 810 may identify one or more potential risks in the capabilities of the new AI agent 160. In particular, subprocess 810 may perform risk analysis on the capabilities of the new AI agent 160. The capabilities of the new AI agent 160 may comprise an aggregation of the capabilities of each of the tools 164 that were identified in subprocess 360, for example, as extracted or otherwise derived from the tool definitions of the identified tools 164, and/or the tasks output by subprocess 350 (e.g., task templates 515). Subprocess 810 may utilize one or more rules to classify the capabilities into potential risks.

Continuing the example from the previous section, the potential risks, output by subprocess 810, may be:

```
{
  “identified_risks”: [
    {
      “risk_type”: “data_access”,
      “description”: “Potential access to private repository
      content”,
      “severity”: “medium”,
      “likelihood”: “high”
    },
    {
      “risk_type”: “sensitive_data_exposure”,
      “description”: “Risk of exposing credentials in
      notifications”,
      “severity”: “high”,
      “likelihood”: “low”
    },
    {
      “risk_type”: “platform_abuse”,
      “description”: “Potential to exceed GitHub API rate
      limits”,
      “severity”: “low”,
      “likelihood”: “medium”
    }
  ]
}
```

Subprocess 820 may select one or more policy templates based on the potential risk(s), identified in subprocess 810. Each policy template represents a type of guardrail that is designed to mitigate one or more potential risks, and may comprise or consist of the name of the guardrail, a description of the guardrail, and/or the like. Subprocess 820 may utilize one or more rules to classify potential risks into guardrails, represented by the policy templates.

Continuing the example above, the policy templates, output by subprocess 820, may be:

```
{
  “recommended_policies”: [
    {
      “policy_type”: “scope_limitation”,
      “risk_addressed”: “data_access”,
      “implementation”: “strict_repository_access”
    },
    {
      “policy_type”: “content_filter”,
      “risk_addressed”: “sensitive_data_exposure”,
      “implementation”: “pattern_matching”
    },
    {
      “policy_type”: “rate_limiting”,
      “risk_addressed”: “platform_abuse”,
      “implementation”: “request_throttling”
    }
  ]
}
```

Subprocess 830 may, for each policy template output by subprocess 820, set one or more parameters, and generally a plurality of parameters, to define a policy instance that represents a guardrail for the new AI agent 160. In other words, subprocess 830 may set the value of each of one or more parameters in each policy template, to configure each policy template into a policy instance, which may be referred to herein as a “guardrail.” It should be understood that the output of subprocess 830 may consist one policy instance if there is only a single guardrail determined for the new AI agent 160, or a plurality of policy instances if there are a plurality of guardrails determined for the new AI agent 160.

Continuing the example above, the policy instances, output by subprocess 830, may be:

```
“guardrails”: {
  “blocked_message”: “I cannot access unauthorized repositories
  or expose sensitive information.”,
  “policies”: [
    {
      “name”: “Repository Access Control”,
      “type”: “scope_limitation”,
      “configuration”: {
        “description”: “Limit access to explicitly authorized
        repositories only”,
        “enforcement”: “strict”,
        “error_message”: “I can only access repositories you
        have explicitly granted permission for.”
      }
    },
    {
      “name”: “Sensitive Content Filter”,
      “type”: “content_filter”,
      “configuration”: {
        “patterns”: [
    “\ \b(?:password|secret|token|key) \ \s* [=: ] \ \s* [\ \w\ \d] + \ \b”,
    “-----BEGIN\ \s+ (?:RSA|DSA|EC|OPENSSH|PRIVATE) \ \s+KEY-----”
        ],
        “action”: “redact”,
        “message”: “I've detected what appears to be sensitive
        information and have redacted it.”
      }
    },
    {
      “name”: “Rate Limit Compliance”,
      “type”: “rate_limiting”,
      “configuration”: {
        “max_requests_per_hour”: 50,
        “cooldown_period”: “10m”,
        “message”: “I need to pause GitHub API requests
        temporarily to comply with rate limits.”
      }
    }
  ]
}
```

### 8. User Interactions

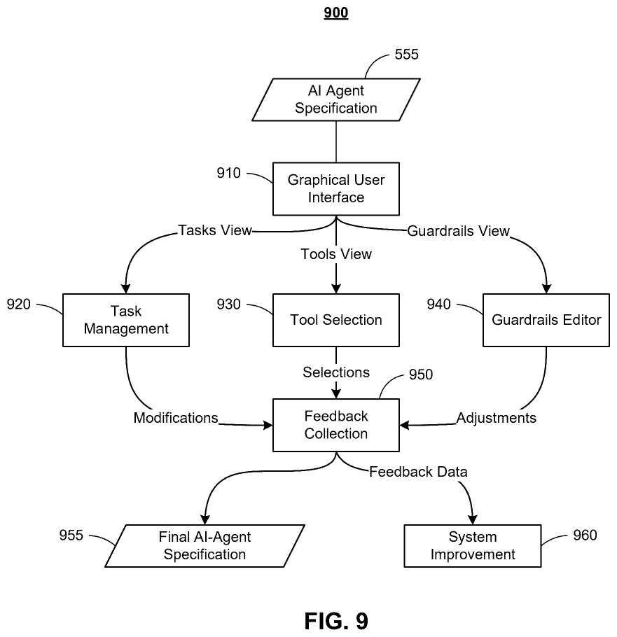

FIG. 9 illustrates an example of a process 900 for interacting with a user to finalize an AI-agent specification, according to an embodiment. Process 900 may be implemented by generation engine 116 and/or server application 112 (e.g., via user interface 115). While process 900 is illustrated with a certain arrangement and ordering of components, process 900 may be implemented with fewer, more, or different components and a different arrangement and/or ordering of components. Furthermore, any component, which does not depend on the completion of another component, may be executed before, after, or in parallel with that other independent component, even if the components are described or illustrated in a particular order.

At a high level, process 900 presents the generated AI-agent specification to the user for review, and captures the user's feedback, for modification of the AI-agent specification and, optionally, continuous improvement of generation engine 116. The user interface may provide several key functions: visualization; editing; validation; and feedback capture. Visualization presents the AI-agent specification in an intuitive format. Editing provides an interface that enables user modification of all components of the AI-agent specification. Validation ensures that the user modifications maintain technical validity. Feedback capture records the user modifications for improvement of generation engine 116 (e.g., by statistically analyzing feedback patterns). These functions may all be comprised in a web interface or other graphical user interface.

AI-agent specification 555 may be output to graphical user interface 910, which may be comprised in user interface 115 and/or chat interface 165, depending on how generation engine 116 is implemented. In particular, AI-agent specification 555, which, at this point, may be populated with task sequence with instructions 535, agent metadata 545, a set of one or more tools 164, and a set of one or more policy instances, representing respective guardrails, may be displayed within graphical user interface 910. Each of the components of AI-agent specification 555, including the task sequence with instructions 535, agent metadata 545, tool(s) 164, and policy instance(s), may be presented, in one or more screens and/or frames of graphical user interface 910, in association with one or more inputs (e.g., textboxes, drop-down menus, virtual buttons, etc.) that enable the user to modify each component. For example, the graphical user interface may provide a tasks view for modifying task sequence with instructions 535 for the new AI agent 160, a tools view for modifying the selection of tool(s) 164 to be utilized by the new AI agent 160, and a guardrails view for modifying the policy instance(s) applicable to the new AI agent 160.

The tasks view provide task management 920. In particular, the user may modify the tasks that were determined in subprocess 350. Modification of a task may comprise editing a task (e.g., any of the elements of task sequence with instructions 535), changing the order of a task in the task sequence, adding a task, deleting a task, editing, adding, or deleting an instruction associated with a task, and/or the like.

The tools view provides tool selection 930. In particular, the user may select from the tools 164 that were identified in subprocess 360. For example, the tools view may present the user with one or more tool options for each task. For each task, the user may select one of the tool option(s) to be utilized for that task, select a different tool 164 to be utilized for that task, and/or the like.

The guardrails view provides a guardrails editor 940 that can be used to adjust the guardrail(s) generated in subprocess 370. Adjustment of a guardrail may comprise editing a guardrail (e.g., editing a value of a parameter within the policy instance), adding a guardrail (e.g., by inputting values of parameter(s) in a policy template to define a new policy instance), deleting a guardrail, and/or the like.

The modification(s), if any, from task management 920, the selection(s), if any, from tool selection 930, and/or the adjustments, if any, from guardrails editor 940, which may all be referred to herein as “modifications,” may be provided as inputs to feedback collection 950. Feedback collection 950 may record patterns in the modifications to the tasks (e.g., the addition of more specific instructions), preferences in the selection of tools 164 (e.g., a preference for event-driven vs. polling approaches), and patterns in the adjustments to the guardrails (e.g., the addition of patterns to the sensitive content filter) into feedback data that may be used in system improvement 960 to improve generation engine 116 for the particular user and/or all users. Continuing the example above, the feedback data may be:

```
{
  “specification_id”: “spec-12345”,
  “user_id”: “user-789”,
  “modifications”: [
    {
      “component”: “task”,
      “task_id”: 2,
      “field”: “instructions”,
      “type”: “addition”,
      “content”: “Consider the repository's main programming
      languages when suggesting tags”
    },
    {
      “component”: “tool”,
      “task_id”: 1,
      “original_tool_id”: “github-api-connector”,
      “selected_tool_id”: “webhook-handler”,
      “reason”: “prefer_event_driven”
    }
  ],
  “explicit_feedback”: {
    “rating”: 4,
    “comments”: “Good overall but needed more language-specific
    tagging logic”
  }
}
```

The result of task management 920, tool selection 930, and/or guardrails editor 940, is a final AI-agent specification 955. If no modifications, selections, or adjustments were made, final AI-agent specification 955 may be identical to the fully populated initial AI-agent specification 555. Otherwise, final AI-agent specification 955 will differ from initial AI-agent specification 555 by virtue of the modifications, selections, and/or adjustments. Final AI-agent specification 555 may subsequently be used to generate the new AI agent 160 in subprocess 390.

### 9. Full Example

For the purposes of illustration and understanding, a full concrete example of the entire process 300 will now be provided. In this example, input 405 is:
I need an agent that can retrieve, classify, and update case types in Salesforce, and create relevant ServiceNow incidents for them.

From this input 405, model 420 may output the following intent classification 422 and named entities 424:

```
{
  “intent_type”: “integration_workflow”,
  “confidence”: 0.94,
  “entities”: {
    “platforms”: [
      {“name”: “Salesforce”, “confidence”: 0.98},
      {“name”: “ServiceNow”, “confidence”: 0.97}
    ],
    “objects”: [
      {“name”: “case”, “confidence”: 0.96},
      {“name”: “incident”, “confidence”: 0.95}
    ],
    “actions”: [
      {“verb”: “retrieve”, “object”: “case”, “platform”:
      “Salesforce”, “confidence”: 0.93},
      {“verb”: “classify”, “object”: “case”, “platform”:
      “Salesforce”, “confidence”: 0.91},
      {“verb”: “update”, “object”: “case”, “attribute”: “type”,
      “platform”: “Salesforce”, “confidence”: 0.89},
      {“verb”: “create”, “object”: “incident”, “platform”:
      “ServiceNow”, “qualifier”: “relevant”, “confidence”:
      0.92}
    ]
  }
}
```

From these intent classification 422 and named entities 422, structuring module 430 may output the following structured intent 435:

```
{
  “primary_intent”: “integration_workflow”,
  “workflow”: {
    “source_system”: “Salesforce”,
    “target_system”: “ServiceNow”,
    “data_flow”: [
      {“operation”: “retrieve”, “system”: “Salesforce”,
      “object”: “case”},
      {“operation”: “process”, “type”: “classification”,
      “object”: “case”},
      {“operation”: “update”, “system”: “Salesforce”, “object”:
      “case”, “attribute”: “type”},
      {“operation”: “create”, “system”: “ServiceNow”, “object”:
      “incident”, “based_on”: “case”}
    ]
  },
  “confidence_score”: 0.88
}
```

Based on this structured intent 435, task decomposition 510 may output the following task templates 515:

```
{
  “tasks”: [
      {
        “task_type”: “data_retrieval”,
        “description”: “Retrieve cases from Salesforce”,
        “importance”: “high”,
        “frequency”: “on_demand”
      },
      {
        “task_type”: “data_presentation”,
        “description”: “Generate case summary”,
        “importance”: “medium”,
        “dependencies”: [“data_retrieval”]
      },
      {
        “task_type”: “data_processing”,
        “description”: “Identify case type”,
        “importance”: “high”,
        “dependencies”: [“data_retrieval”]
      },
      {
        “task_type”: “data_update”,
        “description”: “Update case type in Salesforce”,
        “importance”: “high”,
        “dependencies”: [“data_processing”]
      },
      {
        “task_type”: “system_integration”,
        “description”: “Create ServiceNow incident”,
        “importance”: “high”,
        “dependencies”: [“data_update”]
      }
  ]
}
```

Based on these task templates 515, the resulting task sequence with instructions 535, output by instruction generation 530, may be:

```
{
  “tasks”: [
    {
      “name”: “Retrieve Open Cases”,
      “objective”: “Fetch all currently open support cases”,
      “instructions”: [
        “Query Salesforce for cases with ‘Open’ status”,
        “Compile list of open cases with key details, ensuring
        all attributes in the response remain intact,
        including Id”,
        “Prepare summary report of open cases”,
        “Present results in a well-formatted table
        highlighting case number, subject, priority, and
        creation date”,
        “Include a count of total open cases at the top of the
        response”
      ]
    },
    // Other tasks follow the same pattern
  ]
}
```

Further based on the above structured intent 435, personality trait mapping 540 may produce the following values of personality traits, based on a rule-based analysis that derives a professional voice tone 615A from the intent for an integration workflow, high clarity 615D and confidence 615E from the intent for enterprise systems, high decisiveness 615C and engagement 615F from the intent for a cross-system workflow, and moderate-to-high creativity 615B based on the intent for case classification:

```
“personality_traits”: {
  “voice_tone”: “Professional”,
  “creativity”: 80,
  “decisiveness”: 90,
  “clarity”: 100,
  “confidence”: 100,
  “engagement”: 100
}
```

The capabilities, identified by subprocess 720, may be:

```
{
  “required_capabilities”: [
    {“type”: “api_integration”, “platform”: “Salesforce”,
    “operation”: “read”, “confidence”: 0.97},
    {“type”: “data_formatting”, “purpose”:
    “tabular_presentation”, “confidence”: 0.85}
  ]
}
```

From these capabilities, a single tool 164 may be identified by subprocess 360:

```
“tools”: [
  {
    “id”: “7f3ffe33-bc2d-4431-96d7-cd5f7791e193”,
    “type”: “OpenAPI”,
    “requires_approval”: false,
    “response_passthrough”: false
  }
]
```

Based on the above structured intent 435 and this identified tool 164, the guardrails, output by subprocess 370, may be:

```
“guardrails”: {
  “blocked_message”: “I cannot access or disclose confidential
  customer information without proper authorization.”,
  “policies”: [
    {
      “name”: “Data Privacy”,
      “type”: “denied_topic”,
      “configuration”: {
        “description”: “Prevent access to sensitive customer
        information”,
        “sample_phrases”: [
          “Show me customer personal details”,
          “Retrieve full customer contact information”,
          “Disclose confidential case notes”
        ]
      }
    },
    // Additional policies follow
  ]
}
```

Based on the identified tool 164 and the above guardrails, the final AI-agent specification 955 may be:

```
{
  “objective”: “Retrieve, Classify and Update Case type in
  Salesforce, and create relevant ServiceNow incident for it”,
  “name”: “SFCasePortal”,
  “provider_name”: “Boomi”,
  “provider_id”: “boomi”,
  “personality_traits”: {
    “voice_tone”: “Professional”,
    “creativity”: 80,
    “decisiveness”: 90,
    “clarity”: 100,
    “confidence”: 100,
    “engagement”: 100
  },
  // Full specification continues
}
```

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, by a generation engine:
receive an input;
determine an intent for a new artificial intelligence (AI) agent, based on the input;
determine one or more tasks to be performed by the new AI agent, based on the intent;
identify one or more tools to be used by the new AI agent, based on one or both of the intent or the one or more tasks;
generate one or more guardrails for the new AI agent, based on one or more of the intent, the one or more tasks, or the one or more tools; and
output a recommended AI-agent specification for the new AI agent that specifies the one or more tasks, the one or more tools, and the one or more guardrails.

2. The method of claim 1, wherein the input is received from a user, and wherein the method further comprises using the at least one hardware processor to:
receive feedback regarding the recommended AI-agent specification from the user;
update the recommended AI-agent specification, based on the feedback; and
output the updated recommended AI-agent specification.

3. The method of claim 1, further comprising using the at least one hardware processor to:
receive approval of the recommended AI-agent specification; and
in response to the approval, generate a new AI agent, according to the approved AI-agent specification.

4. The method of claim 1, wherein identifying the one or more tools comprises, for each of the one or more tasks, identifying at least one tool that performs that task.

5. The method of claim 1, wherein determining the intent comprises:
preprocessing the input;
applying a machine-learning model to the preprocessed input to produce both an intent classification for the input and one or more named entities, if any, in the input; and
structuring the intent classification and the one or more named entities, if any, into a structured intent, wherein the one or more tasks are determined based on the structured intent.

6. The method of claim 5, wherein the machine-learning model comprises a Robustly Optimized Bidirectional Encoder Representations from Transformers approach Large (ROBERTa-Large) model.

7. The method of claim 1, wherein determining one or more tasks comprises:
decomposing the intent, represented as a structured intent, into one or more task templates;
determine an execution order of the one or more tasks represented by the one or more task templates;
generate a set of one or more instructions for each of the one or more tasks; and
populating an initial AI-agent specification with the one or more tasks, according to the determined execution order, and the set of one or more instructions for each of the one or more tasks.

8. The method of claim 7, wherein generating the one or more instructions for each of the one or more tasks comprises:
generating a prompt that instructs a generative language model to generate a set of instructions for implementing the task; and
applying the generative language model to the prompt to produce an output comprising the set of one or more instructions for implementing the task.

9. The method of claim 7, further comprising using the at least one hardware processor to:
determine a value of each of a plurality of personality traits for the new AI agent based on the structured intent; and
populate the initial AI-agent specification with the value of each of the plurality of personality traits.

10. The method of claim 9, wherein the plurality of personality traits comprises two or more of voice tone, creativity, decisiveness, clarity, confidence, or engagement.

11. The method of claim 1, wherein identifying one or more tools comprises, for each of the one or more tasks:
identify one or more capabilities required by the task;
match each of the one or more capabilities to one or more matching tools within a tool registry; and
generate a configuration for each of the one or more matching tools.

12. The method of claim 1, wherein generating one or more guardrails comprises:
identify one or more potential risks of the new AI agent, based on capabilities of the new AI agent;
select one or more policy templates based on the one or more potential risks; and
set a value of each of one or more parameters in each of the one or more policy templates, to define a policy instance that represents a guardrail.

13. The method of claim 1, wherein the generation engine is an AI agent.

14. The method of claim 1, wherein the generation engine implements a real-time chat session, wherein the input is received from a user within the real-time chat session, and wherein the recommended AI-agent specification is output to the user, within the real-time chat session, as a response to the input.

15. The method of claim 1, further comprising using the at least one hardware processor to, by the generation engine:
receive one or more modifications to the recommended AI-agent specification, wherein at least one of the one or more modifications is to one or more of at least one of the one or more tasks, at least one of the one or more tools, or at least one of the one or more guardrails; and
update the recommended AI-agent specification according to the one or more modifications, to produce a final AI-agent specification.

16. The method of claim 1, further comprising using the at least one hardware processor to:
generate feedback data representing one or more patterns in the one or more modifications; and
update the generation engine based on the feedback data.

17. The method of claim 1, further comprising using the at least one hardware processor to:
generate the new AI agent according to a final AI-agent specification comprising or derived from the recommended AI-agent specification; and
deploy the new AI agent to a computing environment.

18. The method of claim 17, wherein the computing environment is an integration platform as a service (iPaaS) platform.

19. A system comprising:
at least one hardware processor; and
software that is configured to, when executed by the at least one hardware processor,
receive an input,
determine an intent for a new artificial intelligence (AI) agent, based on the input,
determine one or more tasks to be performed by the new AI agent, based on the intent,
identify one or more tools to be used by the new AI agent, based on one or both of the intent or the one or more tasks,
generate one or more guardrails for the new AI agent, based on one or more of the intent, the one or more tasks, or the one or more tools, and
output a recommended AI-agent specification for the new AI agent that specifies the one or more tasks, the one or more tools, and the one or more guardrails.

20. A non-transitory computer-readable medium having instructions stored therein, wherein the instructions, when executed by a processor, cause the processor to:
receive an input;
determine an intent for a new artificial intelligence (AI) agent, based on the input;
determine one or more tasks to be performed by the new AI agent, based on the intent;
identify one or more tools to be used by the new AI agent, based on one or both of the intent or the one or more tasks;
generate one or more guardrails for the new AI agent, based on one or more of the intent, the one or more tasks, or the one or more tools; and
output a recommended AI-agent specification for the new AI agent that specifics the one or more tasks, the one or more tools, and the one or more guardrails.
